(19) United States
(12) Patent Application Publication
(10) Pub. No.: US 2010/0191573 A1
(43) Pub. Date: Jul. 29, 2010

(54) COMPUTER SYSTEM AND METHOD OF DETERMINING TARGET SUBSET OF DATA BASED ON MEASURED PARAMETER

(75) Inventor: Michael David Andrew, San Francisco, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Mediasmith, Inc., San Francisco, CA (US)

(21) Appl. No.: 12/360,791

(22) Filed: Jan. 27, 2009

(51) Int. Cl. G06F 17/30; G06Q 10/00; G06Q 50/00

(52) U.S. Cl. 705/10; 707/E17.017

(57) ABSTRACT

The invention provides a computer-based method of determining target subset of data based on measured parameter comprising (i) storing a set of keyword phrases in at least one computer-readable storage medium, (ii) storing a set of measured parameters in said at least one computer-readable storage medium, each measured para meter being associated with a respective one of the keyword phrases, (iii) receiving at least one common sub phrase in at least one computer processor connected to said at least one computer-readable storage medium due to entry of said sub phrase by a user utilizing a computer input device connected to the computer processor, (iv) operating said at least one computer processor to extract a subset of keyword phrases having the common sub phrase from the keyword phrases, (v) operating said at least one computer processor to aggregate the extracted keyword phrases to determine a total measured parameter for each extracted keyword phrase, each total measured parameter being a function of the measured parameters of the extracted keyword phrases, (vi) receiving a targeting criteria in said at least one computer processor due to entry of said targeting criteria by a user utilizing a computer input device connected to the computer processor, (vii) operating said at least one computer processor to select a subset of the aggregated keyword phrases based on the targeting criteria; and (viii) displaying the subset by a display device connected to said at least one computer processor, including a display of the total measured parameter aggregated for each keyword phrase extracted based on the common sub phrase, the extracted keyword phrases further selected due to matching of the targeting criteria.

### BACKGROUND OF THE INVENTION

1) Field of the Invention

This invention relates to a computer system for and a computer-based method of determining target subset of data based on measured parameter.

2) Discussion of Related Art

Due to ubiquitous use of the Internet, the capabilities of computer systems and computer storage space has become increasingly inexpensive and companies are collecting increasing amounts of Internet traffic data. The amount of data is often so enormous that it is difficult or impossible to make any sense of it. A company that is running a campaign on a search engine, for example, may have so many keyword phrases and other measured parameters based on user searches that it may be difficult to determine user patterns from the data for purposes of future campaigns.

### SUMMARY OF THE INVENTION

The invention provides a computer-based method of determining target subset of data based on measured parameter comprising (i) storing a set of keyword phrases in at least one computer-readable storage medium, (ii) storing a set of measured parameters in said at least one computer-readable storage medium, each measured parameter being associated with a respective one of the keyword phrases, (iii) receiving at least one common sub phrase in at least one computer processor connected to said at least one computer-readable storage medium due to entry of said sub phrase by a user utilizing a computer input device connected to the computer processor, (iv) operating said at least one computer processor to extract a subset of keyword phrases having the common sub phrase from the keyword phrases, (v) operating said at least one computer processor to aggregate the extracted keyword phrases to determine a total measured parameter for each extracted keyword phrase, each total measured parameter being a function of the measured parameters of the extracted keyword phrases, (vi) receiving a targeting criteria in said at least one computer processor due to entry of said targeting criteria by a user utilizing a computer input device connected to the computer processor, (vii) operating said at least one computer processor to select a subset of the aggregated keyword phrases based on the targeting criteria; and (viii) displaying the subset by a display device connected to said at least one computer processor, including a display of the total measured parameter aggregated for each keyword phrase extracted based on the common sub phrase, the extracted keyword phrases further selected due to matching of the targeting criteria.

The computer-based method of determining target subset of data based on measured parameter may further include displaying the keyword phrases and the associated measured parameter stored in (i) and (ii) by the display device before receiving the common sub phrase in (iii).

The computer-based method of determining target subset of data based on measured parameter, wherein the sub phrase is entered on an interface displayed by the display device.

The computer-based method of determining target subset of data based on measured parameter, wherein the interface has a find button, further comprising receiving a command at said at least one processor when a user selects the find button, and operating said at least one processor to display a find field for entering the sub phrase in response to receiving the command at said at least one processor when the user selects the find button.

The computer-based method of determining target subset of data based on measured parameter wherein the function of the measured parameters is a sum total of the measured parameters.

The computer-based method of determining target subset of data based on measured parameter may further include displaying the keyword phrases and the total measured parameter extracted in (iv) and aggregated in (v) by the display device before receiving the targeting criteria in (vi).

The computer-based method of determining target subset of data based on measured parameter, wherein the targeting criteria is entered on an interface displayed by the display device.

The computer-based method of determining target subset of data based on measured parameter, wherein the interface has a refine button, may further include receiving a command at said at least one processor when a user selects the refine button, and operating said at least one processor to display a refine field for entering the targeting criteria in response to receiving the command at said at least one processor when the user selects the refine button.

The computer-based method of determining target subset of data based on measured parameter according may further include (ix) receiving at least a first expansion criteria in the at least one computer processor due to entry of said first expansion criteria by a user utilizing a computer input device connected to the computer processor, (x) operating said at least one computer processor to extract a subset of keyword phrases having the first expansion criteria from the keyword phrases, at least some of the keyword phrases having the first expansion criteria being in addition to the keyword phrases extracted in (iv), (xi) operating said at least one computer processor to aggregate the extracted keyword phrases having the first expansion criteria to determine a total measured parameter for each extracted keyword phrase having first expansion criteria, each total measured parameter being a function of the measured parameters of the extracted keyword phrases having the first expansion criteria; and (xii) displaying the keyword phrases having first expansion criteria by a display device together with the subset displayed in (viii), including a display of the total measured parameter aggregated for each keyword phrase extracted based on the expansion criteria.

The computer-based method of determining target subset of data based on measured parameter, wherein the expansion criteria received in (ix) is received after displaying the subset in (viii).

The computer-based method of determining target subset of data based on measured parameter wherein the expansion criteria is a common sub phrase and the keyword phrases extracted in (x) are keyword phrases having the common sub phrase from the keyword phrases.

The computer-based method of determining target subset of data based on measured parameter, wherein the expansion criteria is entered on an interface displayed by the display device.

The computer-based method of determining target subset of data based on measured parameter, wherein the interface has an expansion button, further including receiving a command at said at least one processor when a user selects the expansion button, and operating said at least one processor to display an expansion field for entering the expansion criteria in response to receiving the command at said at least one processor when the user selects the expansion button.

The computer-based method of determining target subset of data based on measured parameter, wherein the interface has a cluster area for entering a plurality of searches and executing the searches simultaneously to extract aggregated keyword phrases, whereafter the searches are displayed in the cluster area.

The computer-based method of determining target subset of data based on measured parameter wherein the interface includes a delete selector associated with each search to remove the respective search and a corresponding subset of aggregated extracted keyword phrases.

The computer-based method of determining target subset of data based on measured parameter, wherein the total measured parameter is a total number of conversions, a total number of clicks being associated with each extracted keyword phrase and the interface has cost calculator area with an input cost field and a target cost, further comprising a calculator that calculates the target cost by multiplying the total number of conversions by the amount in the input cost field and dividing by the total number of clicks.

The computer-based method of determining target subset of data based on measured parameter, wherein the interface has a label area for entering at least one label, the label being associated with a search.

The invention further provides a computer system for determining target subset of data based on a measured parameter, comprising at least one computer-readable storage medium, a processor connected to the computer-readable medium, a display device connected to the processor, and a set of instructions on said at least one computer-readable medium, the set of instructions comprising (i) means for storing a set of keyword phrases in said at least one computer-readable storage medium, (ii) means for storing a set of measured parameters in said at least one computer-readable storage medium, each measured parameter being associated with a respective one of the keyword phrases, (iii) means for receiving at least one common sub phrase in said at least one computer processor connected to said at least one computer-readable storage medium due to entry of said sub phrase by a user utilizing a computer input device connected to the computer processor, (iv) means for operating said at least one computer processor to extract a subset of keyword phrases having the common sub phrase from the keyword phrases, (v) means for operating said at least one computer processor to aggregate the extracted keyword phrases to determine a total measured parameter for each extracted keyword phrase, each total measured parameter being a function of the measured parameters of the extracted keyword phrases, (vi) means for receiving a targeting criteria in said at least one computer processor due to entry of said sub phrase by a user utilizing a computer input device connected to the computer processor, (vii) means for operating said at least one computer processor to select a subset of the aggregated keyword phrases based on the targeting criteria; and (viii) means for displaying the subset by the display device, including a display of the total measured parameter aggregated for each keyword phrase extracted based on the common sub phrase, the extracted keyword phrases further selected due to matching of the targeting criteria.

### BRIEF DESCRIPTION OF THE DRAWINGS

The invention is further described by way of example with reference to the accompanying drawings, wherein:

FIG. 1 is a block diagram of a computer system which a set of instructions, for causing the machine to perform any one or more of the methodologies discussed herein, may be executed;

FIG. 2 is a view of a user interface showing keyword phrases, according to an embodiment of the invention;

FIG. 3 is a view of the interface similar to FIG. 2 showing the use of a find button to display a find field;

FIG. 4 is a view of the interface similar to FIG. 3 after a computer processor is then operated to aggregate the extracted keyword phrases 104 to determine a total measured parameter;

FIG. 5 is a view of the interface similar to FIG. 4 showing the use of a refine button to display a refine field;

FIG. 6 is a view of the interface similar to FIG. 5 after a computer processor is then operated to extract the aggregated keyword phrases 104 to determine a total measured parameter;

FIG. 7 is a view of the interface similar to FIG. 6 showing the use of an expansion button to display an expansion field to enter a first expansion criteria;

FIG. 8 is a view of the interface similar to FIG. 7 after the computer processor is thus operated to extract a subset of keyword phrases having the first expansion criteria from the keyword phrases;

FIG. 9 is a view of the interface similar to FIG. 8 showing a cluster area of the interface;

FIG. 10 is a view of the interface similar to FIG. 9 after a delete selector in FIG. 9 is selected;

FIG. 11 is a view of the interface similar to FIG. 10 showing that the total measured parameter can be a total number of conversions and a total number of clicks associated with each extracted keyword phrase, and further showing a cost calculator area;

FIG. 12 is a view of the interface similar to FIG. 11 showing a label area of the interface; and

FIG. 13 is a view of the interface similar to FIG. 12 that allows the user to select a saved label and retrieve the corresponding keyword phrases and related aggregated data.

### DETAILED DESCRIPTION OF THE INVENTION

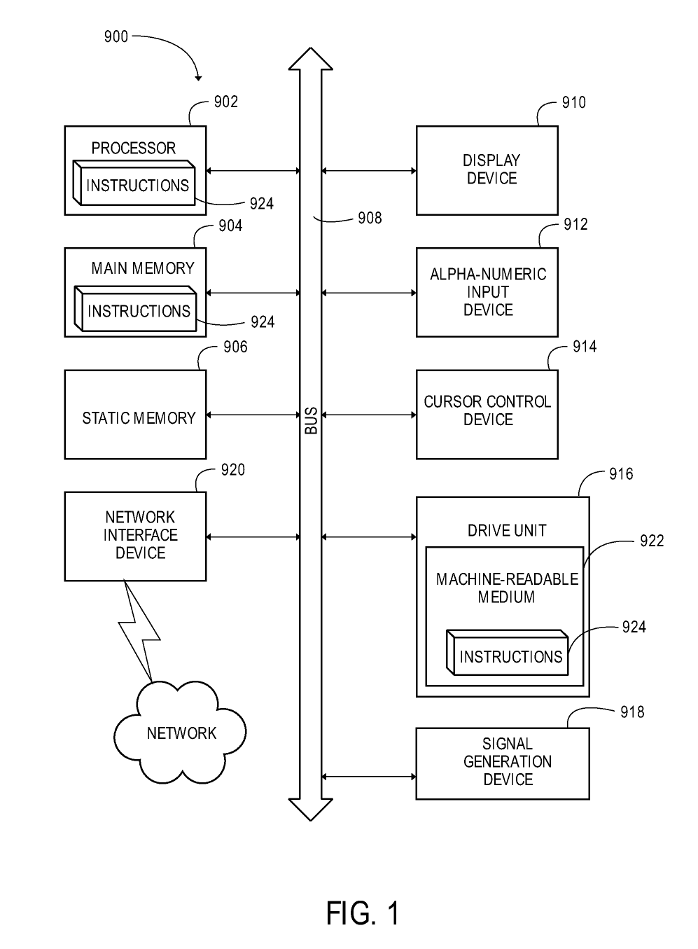

FIG. 1 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 902 (e.g., a central processing unit (CPU), a graphics processing unit (GPU) or both), a main memory 904 (e.g., read only memory (ROM), flash memory, dynamic random access memory (DRAM) such as synchronous DRAM (SDRAM) or Rambus DRAM (RDRAM), etc.), and a static memory 906 (e.g., flash memory, static random access memory (SRAM), etc.), which communicate with each other via a bus 908.

The computer system 900 may further include a display device 910 (e.g., a liquid crystal display (LCD) or a cathode ray tube (CRT)). The computer system 900 also includes an alpha-numeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions 924 (e.g., software) embodying any one or more of the methodologies or functions described herein. The software may also reside, completely or at least partially, within the main memory 904 and/or within the processor 902 during execution thereof by the computer system 900, the main memory 904 and the processor 902 also constituting machine-readable media.

The software may further be transmitted or received over a network 928 via the network interface device 920.

While the machine-readable medium is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories, and optical and magnetic media.

It should be understood that “computer system” as used herein can comprise a single computer or multiple computers that are connected to one another over a network.

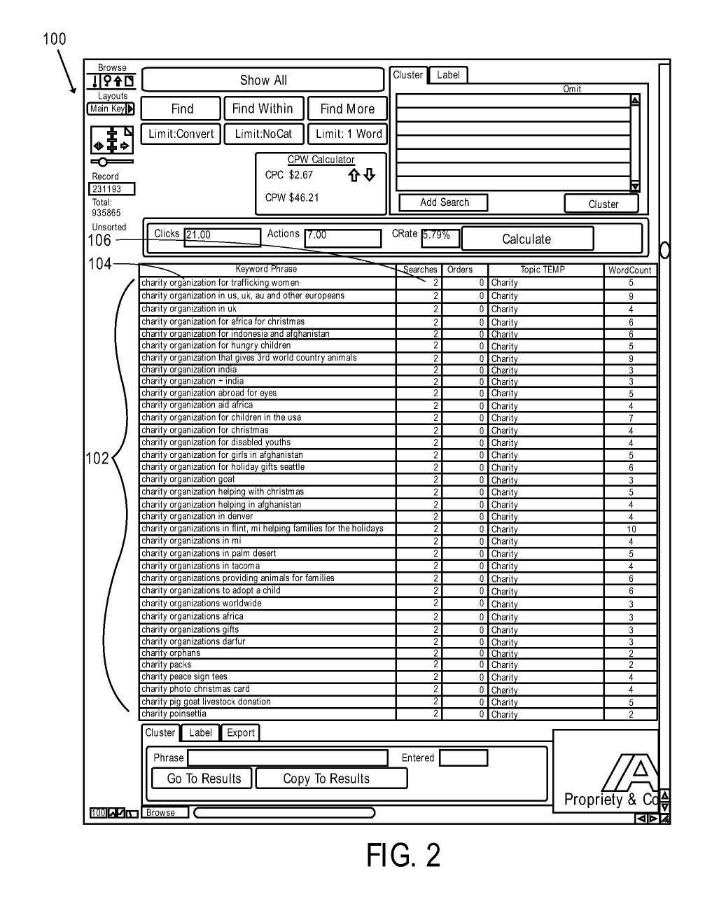

FIG. 2 illustrates an interface 100 forming part of the instructions 924 and is displayed by the display device 910. The interface 100 includes an area 102 for displaying keyword phrases 104 and measured parameters 106. A computer-based method of determining target subset of data based on measured parameter is described. A set of keyword phrases 104 are stored in at least one computer-readable storage medium 904 and 906. A set of measured data is also stored in the computer-readable storage medium 904 and 906, wherein the measured data includes a plurality of measured parameters 106, each measured parameter 106 being associated with a respective one of the keyword phrases 104.

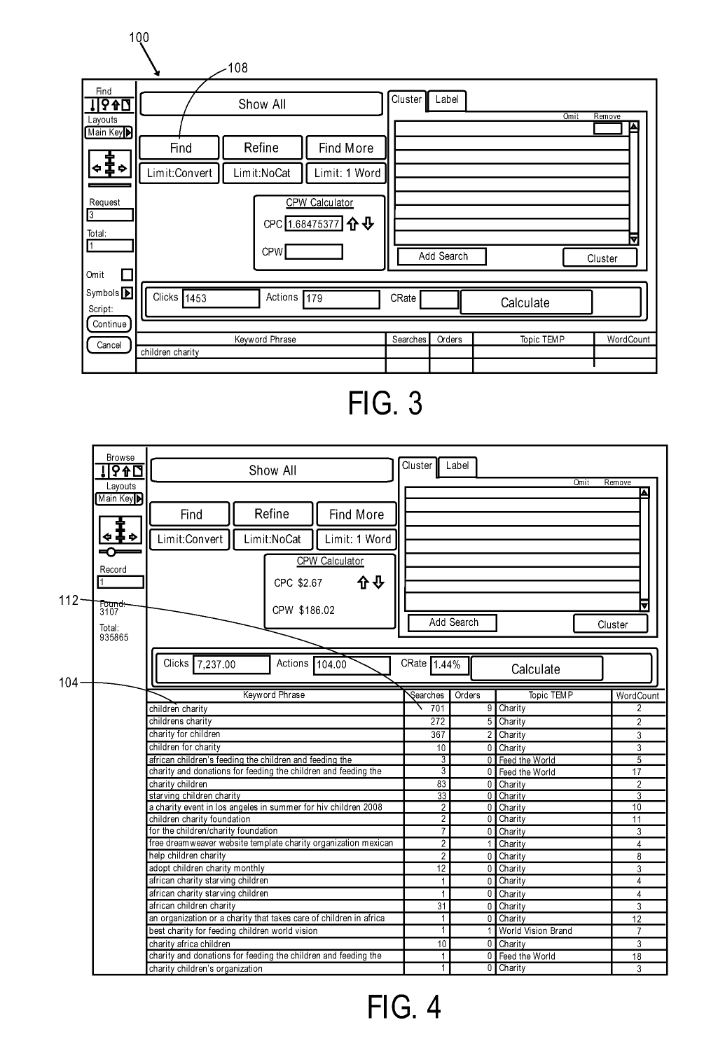

Referring to FIG. 3, the interface 100 has a find button 108. A command is received at the processor 902 when a user selects the find button 108. The processor 902 is operated to display a find field for entering the sub phrase in response to receiving the command at the processor 902 when the user selects the find button 108. The user can then enter at least one common sub phrase (e.g. “children charity”) in the find field of the interface 100 utilizing the cursor control device 914 and the alpha-numeric input device 912 and hit “enter.” The keyword phrases 104 and the associated measured parameter 106 [[stored in]] as described with reference to FIG. 2 are displayed by the display device 910 in FIG. 2 before receiving the common sub phrase in FIG. 3. The common sub phrase is then received in the computer processor 902 connected to the computer-readable storage medium 904 and 906 due to entry of the sub phrase by the user utilizing the alpha-numeric input device 912 connected to the computer processor 902. The computer processor 902 is then operated to extract a subset of keyword phrases 104 having the common sub phrase from the keyword phrases.

As specifically shown in FIG. 4, the computer processor 902 is then operated to aggregate the extracted keyword phrases 104 to determine a total measured parameter 112 for each extracted keyword phrase 104. Each total measured parameter 112 is a function of the measured parameters 106 of the extracted keyword phrases. Specifically, the total measured parameter 112 is a sum total of the measured parameters 106.

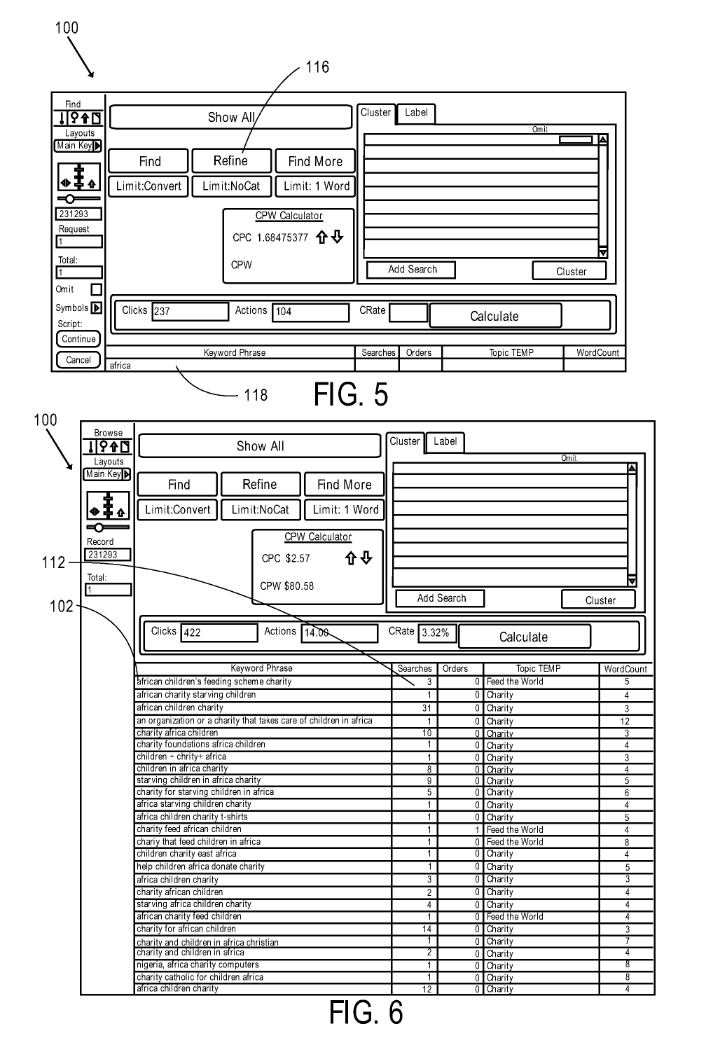

Referring to FIG. 5, the interface 100 also includes a refine button 116. A command is received at the processor 902 when a user selects the refine button 116. The processor 902 is operated to display a refine field 118 for entering the targeting criteria in response to receiving the command at the processor 902 when the user selects the refine button 116. The user can then enter a targeting criteria (e.g., “africa”) in the refine field 118 of the interface 100. The targeting criteria is received in the computer processor 902 due to entry of the targeting criteria by a user utilizing a alpha-numeric input device 912 connected to the computer processor 902. The keyword phrases 104 and the total measured parameter 112 extracted in as described with reference to FIG. 3 and aggregated in as described with reference to FIG. 3 are displayed by the display device 910 in FIG. 3 before receiving the targeting criteria in FIG. 5. The computer processor 902 is operated to select a subset of the aggregated keyword phrases 104 based on the targeting criteria.

As shown in FIG. 6, the subset is displayed by the display device 910 connected to the computer processor 902, including a display of the total measured parameter 112 aggregated for each keyword phrase 104 extracted based on the common sub phrase, the extracted keyword phrases further selected due to matching of the targeting criteria.

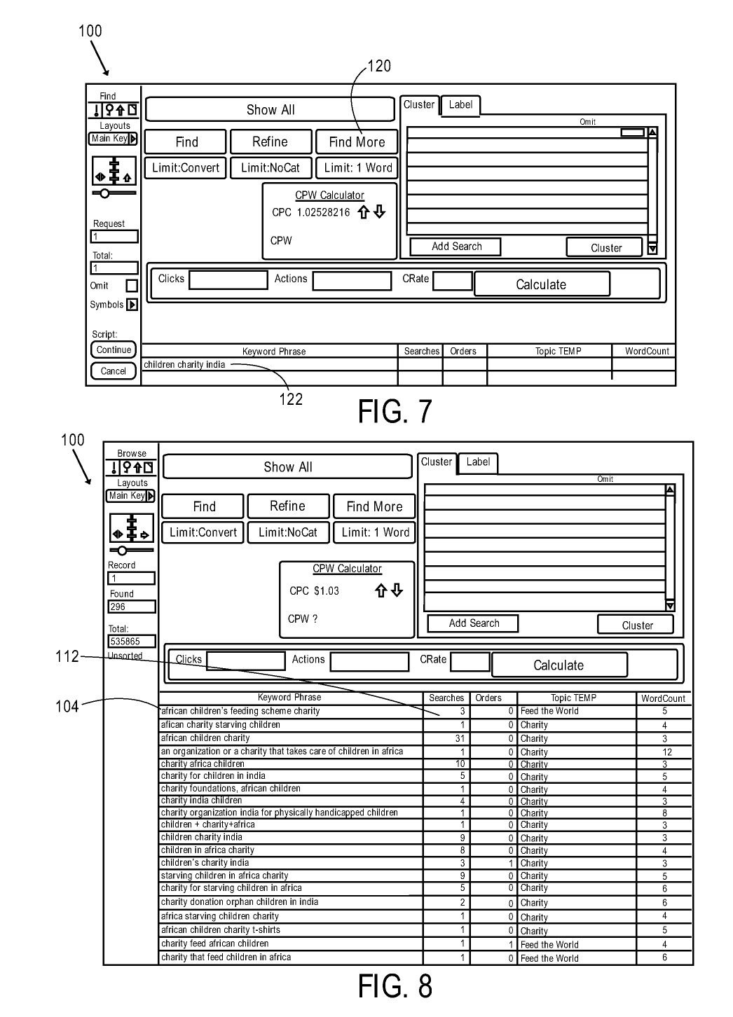

Referring to FIG. 7, the interface 100 also includes an expansion button 120. A command is received at the processor 902 when a user selects the expansion button 120. The processor 902 is operated to display an expansion field 122 for entering the expansion criteria in response to receiving the command at the processor 902 when the user selects the expansion button 120. The user then enters the expansion criteria (e.g., “children charity india”) on the interface 100 displayed by the display device 910. At least a first expansion criteria is then received in the computer processor 902 due to entry of the first expansion criteria by a user utilizing a alpha-numeric input device 912 connected to the computer processor 902.

Referring to FIG. 8, the expansion criteria is thus a common sub phrase (e.g., “children charity india”) and the keyword phrases 104 (e.g., “charity for children in india”) extracted in FIG. 8 are keyword phrases 104 having the common sub phrase from the keyword phrases. The computer processor 902 is thus operated to extract a subset of keyword phrases 104 having the first expansion criteria from the keyword phrases (e.g., “charity for children in india”), at least some of the keyword phrases 104 having the first expansion criteria (“children charity india”) being in addition to the keyword phrases 104 (e.g., “african feeding scheme charity”) extracted in FIG. 6.

The computer processor 902 is then operated to aggregate the extracted keyword phrases 104 having the first expansion criteria to determine a total measured parameter 112 also for each extracted keyword phrase 104 having first expansion criteria, each total measured parameter 112 being a function of the measured parameters 106 of the extracted keyword phrases 104 having the first expansion criteria. The keyword phrases 104 having first expansion criteria are thus also displayed by a display device 910 in FIG. 8 together with the subset displayed in FIG. 6, including a display of the total measured parameter 112 aggregated for each keyword phrase 104 extracted based on the expansion criteria. The expansion criteria received in FIG. 7 is received after displaying the subset in FIG. 6.

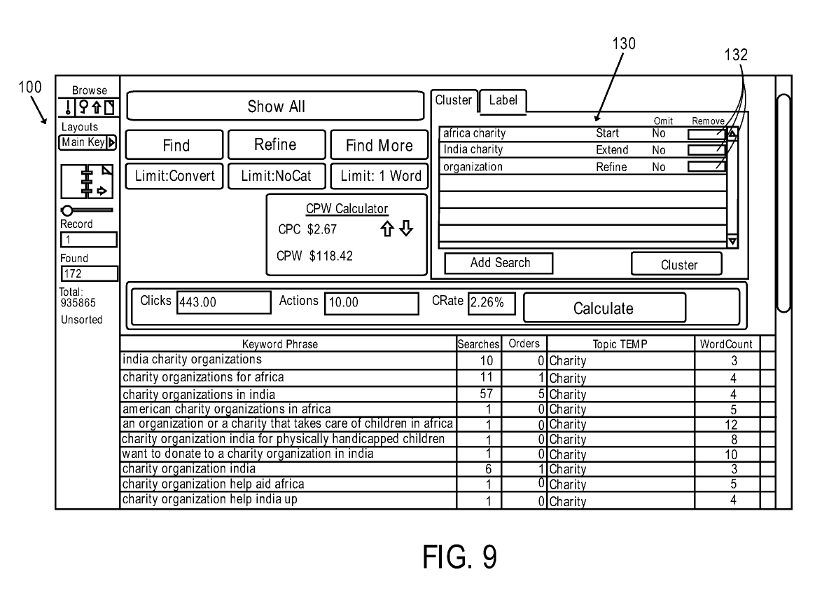

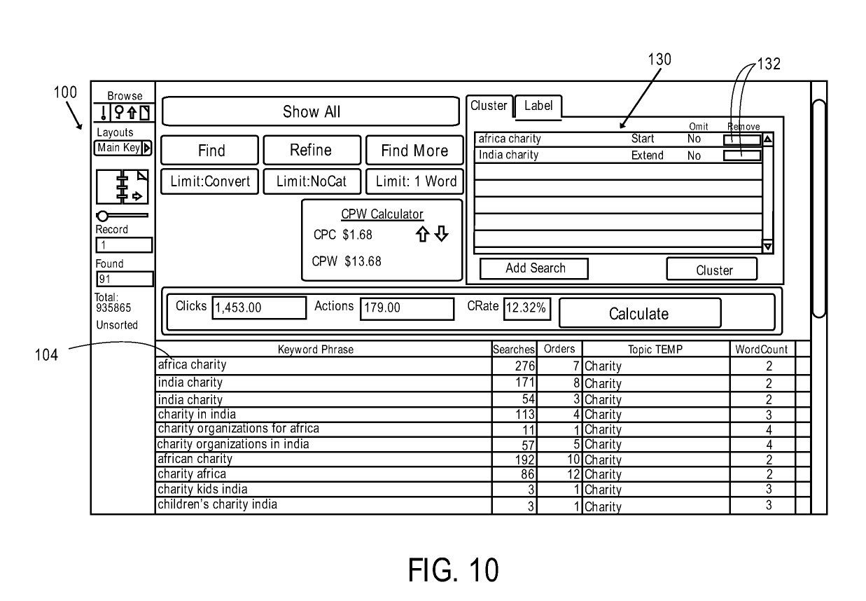

With reference to FIG. 9, the interface 100 has a cluster area 130. A plurality of searches are entered by the user in respective fields of the cluster area. The processor 902 executes the searches simultaneously to extract aggregated keyword phrases, whereafter the searches are displayed in the cluster area. In the present example the processor finds keyword phrases and related aggregated data for “africa charity” and “india charity” terms that also have “organization” in the keyword phrase.

The interface includes a delete selector 132 associated with each search. As shown in FIG. 10, selection of a respective delete selector 132 removes the respective search and a corresponding subset of extracted keyword phrases 104 and associated aggregated data.

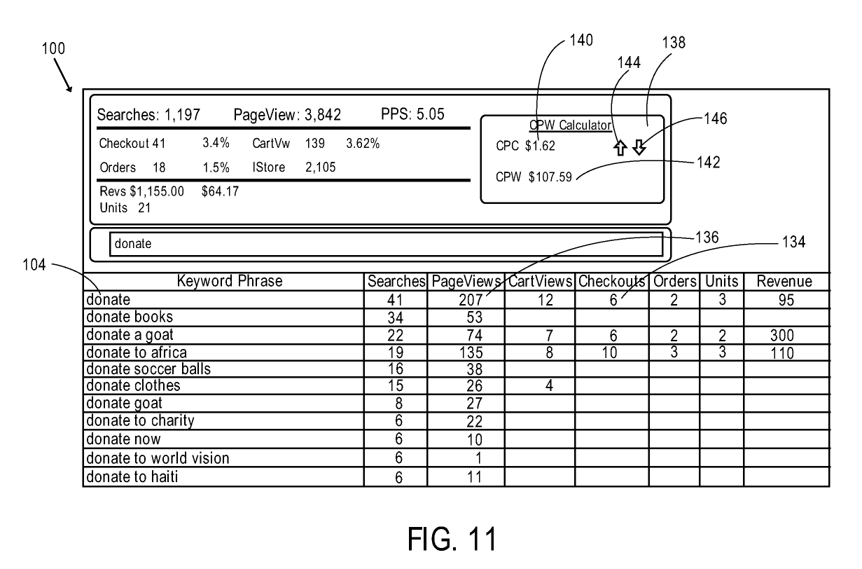

As shown in FIG. 11, the total measured parameter can be a total number of conversions 134 and a total number of clicks 136 can be associated with each extracted keyword phrase 104. The interface 100 has cost calculator area 138 with an input cost field 140 and a target cost 142. The instructions 924 further include a calculator that calculates the target cost 142 by multiplying the total number of conversions 134 by the amount in the input cost field 140 and dividing by the total number of clicks 136. The amount in the input cost field 140 can be adjusted up or down by selecting up or down selectors 144 or 146 respectively.

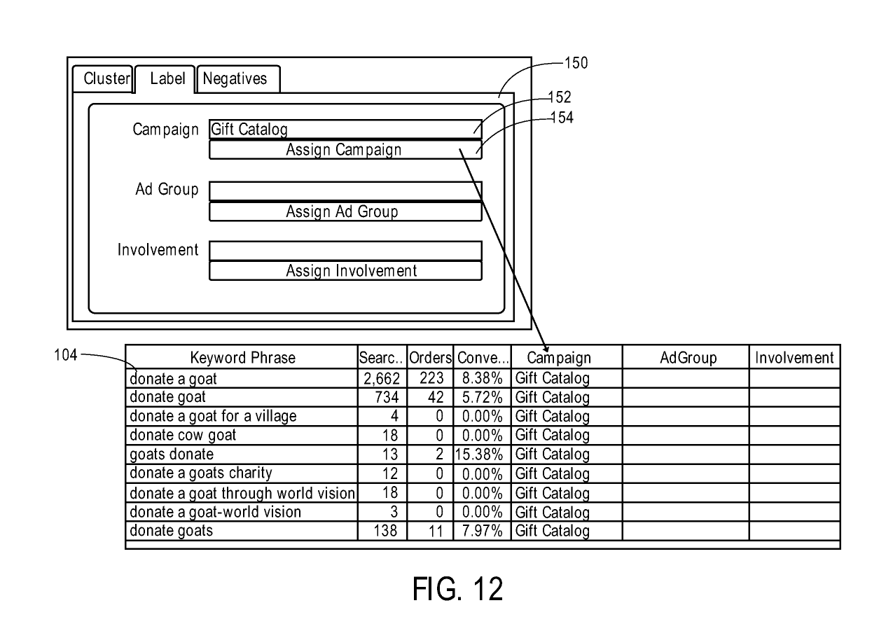

As shown in FIG. 12, the interface 100 has a label area 150 for entering at least one label 152, the label 152 being associated with a search. This allows a user to assign each phrase in a found set of keyword phrases 104 to categories such as a Campaign, an Ad Group, or an Involvement Score. A user enters a string and then clicks save button 154 for keyword phrases to be assigned to each category.

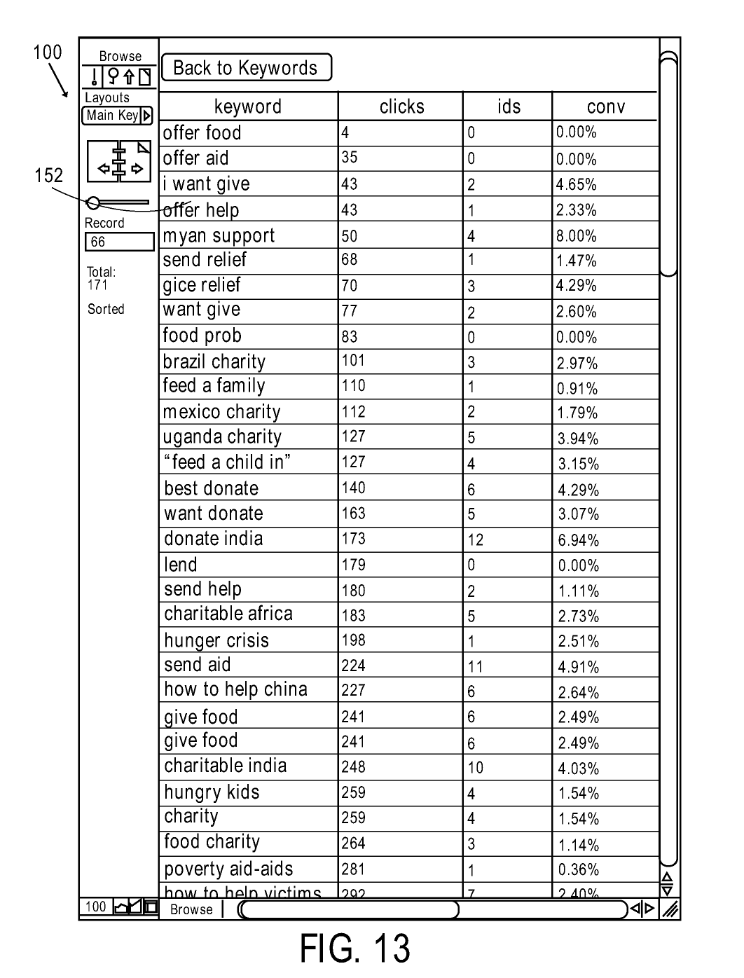

FIG. 13 shows a view of the interface 100 that allows the user to select a saved label 152 and retrieve the corresponding keyword phrases and related aggregated data.

One skilled in the art will appreciate that computer system 900 is also provided for determining target subset of data based on a measured parameter. The computer system includes at least one computer-readable storage medium 904 and 906, a processor 902 connected to the computer-readable medium, a display device 910 connected to the processor 902, and a set of instructions 924 on the computer-readable medium, the set of instructions including: means for storing a set of keyword phrases 104 in the computer-readable storage medium 904 and 906; means for storing a set of measured parameter 106 in the computer-readable storage medium 904 and 906, wherein the measured parameter 106 includes a plurality of measured parameters, each measured parameter 106 being associated with a respective one of the keyword phrases; means for receiving at least one common sub phrase in the computer processor 902 connected to the computer-readable storage medium 904 and 906 due to entry of the sub phrase by a user utilizing a alpha-numeric input device 912 connected to the computer processor 902; means for operating the computer processor 902 to extract a subset of keyword phrases 104 having the common sub phrase from the keyword phrases; means for operating the computer processor 902 to aggregate the extracted keyword phrases 104 to determine a total measured parameter 112 for each extracted keyword phrase, each total measured parameter 112 being a function of the measured parameters 106 of the extracted keyword phrases; means for receiving a targeting criteria in the computer processor 902 due to entry of the sub phrase by a user utilizing a alpha-numeric input device 912 connected to the computer processor 902; means for operating the computer processor 902 to select a subset of the aggregated keyword phrases 104 based on the targeting criteria; and means for displaying the subset by the display device 910, including a display of the total measured parameter 112 aggregated for each keyword phrase 104 extracted based on the common sub phrase, the extracted keyword phases further selected due to matching of the targeting criteria.

As mentioned, due to ubiquitous use of the Internet, the capabilities of computer systems and computer storage space has become increasingly inexpensive and companies are collecting increasing amounts of Internet traffic data. The amount of data is often so enormous that it is difficult or impossible to make any sense of it. With the computer system and method of the invention a company that is running a campaign on a search engine, for example, may find it possible to determine user patterns from the data for purposes of future campaigns even though it may otherwise be difficult to do so because there are so many keyword phrases and other measured parameters based on user searches.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer-based method of determining target subset of data based on measured parameter, comprising:
(i) storing a set of keyword phrases in at least one computer-readable storage medium;
(ii) storing a set of measured parameters in said at least one computer-readable storage medium, each measured parameter being associated with a respective one of the keyword phrases;
(iii) receiving at least one common sub phrase in at least one computer processor connected to said at least one computer-readable storage medium due to entry-of said sub phrase by a user utilizing a computer input device connected to the computer processor;
(iv) operating said at least one computer processor to extract a subset of keyword phrases having the common sub phrase from the keyword phrases;
(v) operating said at least one computer processor to aggregate the extracted keyword phrases to determine a total measured parameter for each extracted keyword phrase, each total measured parameter being a function of the measured parameters of the extracted keyword phrases;
(vi) receiving a targeting criteria in said at least one computer processor due to entry of said targeting criteria by a user utilizing a computer input device connected to the computer processor;
(vii) operating said at least one computer processor to select a subset of the aggregated keyword phrases based on the targeting criteria; and
(viii) displaying the subset by a display device connected to said at least one computer processor, including a display of the total measured parameter aggregated for each keyword phrase extracted based on the common sub phrase, the extracted keyword phrases further selected due to matching of the targeting criteria.

2. A computer-based method of determining target subset of data based on measured parameter according to claim 1, further comprising:
displaying the keyword phrases and the associated measured parameter stored in (i) and (ii) by the display device before receiving the common sub phrase in (iii).

3. A computer-based method of determining target subset of data based on measured parameter according to claim 1, wherein the sub phrase is entered on an interface displayed by the display device.

4. A computer-based method of determining target subset of data based on measured parameter according to claim 3, wherein the interface has a find button, further comprising:
receiving a command at said at least one processor when a user selects the find button; and
operating said at least one processor to display a find field for entering the sub phrase in response to receiving the command at said at least one processor when the user selects the find button.

5. A computer-based method of determining target subset of data based on measured parameter according to claim 1 wherein the function of the measured parameters is a sum total of the measured parameters.

6. A computer-based method of determining target subset of data based on measured parameter according to claim 1 further comprising:
displaying the keyword phrases and the total measured parameter extracted in (iv) and aggregated in (v) by the display device before receiving the targeting criteria in (vi).

7. A computer-based method of determining target subset of data based on measured parameter according to claim 1, wherein the targeting criteria is entered on an interface displayed by the display device.

8. A computer-based method of determining target subset of data based on measured parameter according to claim 7, wherein the interface has a refine button, further comprising:
receiving a command at said at least one processor when a user selects the refine button; and
operating said at least one processor to display a refine field for entering the targeting criteria in response to receiving the command at said at least one processor when the user selects the refine button.

9. A computer-based method of determining target subset of data based on measured parameter according to claim 1, further comprising:
(ix) receiving at least a first expansion criteria in the at least one computer processor due to entry of said first expansion criteria by a user utilizing a computer input device connected to the computer processor;
(x) operating said at least one computer processor to extract a subset of keyword phrases having the first expansion criteria from the keyword phrases, at least some of the keyword phrases having the first expansion criteria being in addition to the keyword phrases extracted in (iv);
(xi) operating said at least one computer processor to aggregate the extracted keyword phrases having the first expansion criteria to determine a total measured parameter for each extracted keyword phrase having first expansion criteria, each total measured parameter being a function of the measured parameters of the extracted keyword phrases having the first expansion criteria; and
(xii) displaying the keyword phrases having first expansion criteria by a display device together with the subset displayed in (viii), including a display of the total measured parameter aggregated for each keyword phrase extracted based on the expansion criteria.

10. A computer-based method of determining target subset of data based on measured parameter according to claim 9, wherein the expansion criteria received in (ix) is received after displaying the subset in (viii).

11. A computer-based method of determining target subset of data based on measured parameter according to claim 9 wherein the expansion criteria is a common sub phrase and the keyword phrases extracted in (x) are keyword phrases having the common sub phrase from the keyword phrases.

12. A computer-based method of determining target subset of data based on measured parameter according to claim 9, wherein the expansion criteria is entered on an interface displayed by the display device.

13. A computer-based method of determining target subset of data based on measured parameter according to claim 12, wherein the interface has an expansion button, further comprising:
receiving a command at said at least one processor when a user selects the expansion button; and
operating said at least one processor to display an expansion field for entering the expansion criteria in response to receiving the command at said at least one processor when the user selects the expansion button.

14. A computer-based method of determining target subset of data based on measured parameter according to claim 1, wherein the interface has a cluster area for entering a plurality of searches and executing the searches simultaneously to extract aggregated keyword phrases, whereafter the searches are displayed in the cluster area.

15. A computer-based method of determining target subset of data based on measured parameter according to claim 14 wherein the interface includes a delete selector associated with each search to remove the respective search and a corresponding subset of aggregated extracted keyword phrases.

16. A computer-based method of determining target subset of data based on measured parameter according to claim 1, wherein the a total measured parameter is a total number of conversions, a total number of clicks being associated with each extracted keyword phrase and the interface has cost calculator area with an input cost field and a target cost, further comprising a calculator that calculates the target cost by multiplying the total number of conversions by the amount in the input cost field and dividing by the total number of clicks.

17. A computer-based method of determining target subset of data based on measured parameter according to claim 1, wherein the interface has a label area for entering at least one label, the label being associated with a search.

18. A computer system for determining target subset of data based on a measured parameter, comprising:
at least one computer-readable storage medium;
a processor connected to the computer-readable medium;
a display device connected to the processor; and
a set of instructions on said at least one computer-readable medium, the set of comprising:
(i) means for storing a set of keyword phrases in said at least one computer-readable storage medium
(ii) means for storing a set of measured parameters in said at least one computer-readable storage medium, each measured parameter being associated with a respective one of the keyword phrases;
(iii) means for receiving at least one common sub phrase in said at least one computer processor connected to said at least one computer-readable storage medium due to entry of said sub phrase by a user utilizing a computer input device connected to the computer processor;
(iv) means for operating said at least one computer processor to extract a subset of keyword phrases having the common sub phrase from the keyword phrases;
(v) means for operating said at least one computer processor to aggregate the extracted keyword phrases to determine a total measured parameter for each extracted keyword phrase, each total measured parameter being a function of the measured parameters of the extracted keyword phrases;
(vi) means for receiving a targeting criteria in said at least one computer processor due to entry of said sub phrase by a user utilizing a computer input device connected to the computer processor;
(vii) means for operating said at least one computer processor to select a subset of the aggregated keyword phrases based on the targeting criteria; and
(viii) means for displaying the subset by the display device, including a display of the total measured parameter aggregated for each keyword phrase extracted based on the common sub phrase, the extracted keyword phrases further selected due to matching of the targeting criteria.
